(19) United States
(12) Patent Application Publication
(10) Pub. No.: US 2007/0266684 A1
(43) Pub. Date: Nov. 22, 2007

(54) Fry pan for removing odor

(76) Inventor: Seok Jae Kwon, Chilgok-gun (KR)

Correspondence Address: HAMRE, SCHUMANN, MUELLER & LARSON, P.C., P.O. BOX 2902, MINNEAPOLIS, MN, 55402-0902, US

(21) Appl. No.: 11/804,810

(22) Filed: May 21, 2007

(30) Foreign Application Priority Data
May 22, 2006 (KR) 10-2006-0045695

(51) Int. Cl. B04C 3/00

(52) U.S. Cl. 55/455

(57) ABSTRACT

The present invention relates to a fry pan for removing an odor comprises a body including an upper half casing and a lower half casing combined together and having a guide passageway formed penetratingly therein in such a manner as to intercommunicate with a side of the inside thereof and the outside thereof, respectively, a discharge opening/closing means disposed at an end of the body for opening/closing the guide passageway, and a grill net mounted along the outer peripheral edge of the body for putting a food to be cooked thereon, so that a food odor and gas and the like produced when cooking is discharged only to the lower portion of the lower half casing due to the air-tightness by a silicon formed along the outer peripheral edges of the discharge opening/closing means and the grill net, respectively, and is combusted by a flame of a gas stove, thereby effectively removing the food odor.

### TECHNICAL FIELD

The present invention relates to a fry pan for removing an odor, and more particularly, to a fry pan for removing an odor, which comprises a body including an upper half casing and a lower half casing combined together and having a guide passageway formed penetratingly therein in such a manner as to intercommunicate with a side of the inside thereof and the outside thereof, respectively, a discharge opening/closing means disposed at an end of the body for opening/closing the guide passageway, and a grill net mounted along the outer peripheral edge of the body for putting a food to be cooked thereon, so that a food odor and gas and the like produced when cooking is discharged only to the lower portion of the lower half casing due to the air-tightness by a silicon formed along the outer peripheral edges of the discharge opening/closing means and the grill net, respectively, and is combusted by a flame of a gas stove, thereby effectively removing the food odor.

### BACKGROUND ART

Generally, when cooking, an inherent odor of foods, a gas produced by combustion, and the like is produced. Particularly, since a bad fishy smell is produced when cooking fish, it is difficult task for the squeamish to cook.

In order to solve the above problems, various kinds of cookery tools such as a grill pan exclusively used to broil fish and so on have been used, but since those cookery tools are complicated in their configuration, the cooking time using those cookery tools and their cost are increased. Above all, the fishy smell is not completely removed.

Further, in order to solve the above general problems, there is disclosed Korean Patent No. 10-0530695 directed to a double-sided fry pan or a fry pan with a lid, in which a pan body has a gas inflow opening formed on the inner surface of a portion thereof which is coupled to a grip, a gas discharge opening formed on the center of the underside thereof, a guide passageway passing from the gas inflow opening to the gas discharge opening so as to allow the gas inflow opening to be communicated with the gas discharge opening, so that organic gas such as fishy smell produced when cooking fish and the like flows into the guide passageway through the gas inflow opening, is discharged to the outside through the gas discharge opening, and then is combusted by a flame of a gas stove so as to remove the fishy smell.

However, the above-mentioned conventional arts have disadvantages in that they cannot be actually fabricated since the production technique of a relatively thin fry pan is possible only in theory in view of the configuration of the guide passageway passing through from the gas inflow opening to the gas discharge opening, and in that even if they are fabricated, the mass production cannot be realized due to the difficulty in their production.

### DISCLOSURE

### Technical Problem

Accordingly, the present invention has been made in an effort to solve the above-mentioned problems occurring in the prior art, and it is an object of the present invention to provide a fry pan for removing an odor, which comprises a body including an upper half casing and a lower half casing combined together and having a guide passageway formed penetratingly therein in such a manner as to intercommunicate with a side of the inside thereof and the outside thereof, respectively, a discharge opening/closing means disposed at an end of the body for opening/closing the guide passageway, and a grill net mounted along the outer peripheral edge of the body for putting a food to be cooked thereon, so that a food odor and gas and the like produced when cooking is discharged only to the lower portion of the lower half casing due to the air-tightness by a silicon formed along the outer peripheral edges of the discharge opening/closing means and the grill net, respectively, and is combusted by a flame of a gas stove, thereby effectively removing the food odor.

### TECHNICAL SOLUTION

In order to accomplish the above objects, according to the present invention, there is provided a fry pan for removing an odor which comprises a body including an upper half casing and a lower half casing combined together and having a guide passageway formed penetratingly therein in such a manner as to intercommunicate with a side of the inside thereof and the outside thereof, respectively, a discharge opening/closing means disposed at an end of the body for opening/closing the guide passageway, and a grill net mounted along the outer peripheral edge of the body for putting foods to be cooked thereon.

Preferably, the upper half casing and a lower half casing has a plurality of loop-shaped support protrusions outwardly protruded from the top and underside surfaces thereof, respectively.

In addition, the guide passageway of the upper and lower half casings has a first guide passageway internally formed in a side of the upper and lower half casings, respectively, and a second guide passageway elongatedly formed on the top and underside surfaces of the upper and lower half casings in such a manner as to be protruded with the same height as that of the loop-shaped protrusions from the top and underside surfaces of the upper and lower half casings. At this time, the second guide passageway has a cross sectional area smaller than that of the first guide passageway.

Further, the cross sectional area of the second guide passageway becomes larger as it goes from one end of the second guide passageway connected to the first guide passageway toward the other end thereof connected to the outside.

Preferably, the discharge opening/closing means includes a discharge bolt valve mounted at an end of the first guide passageway and having a hollow formed in its interior, and an opening/closing ball mounted movably within the guide passageway for opening and closing the hollow of the discharge bolt valve depending on the use position of the upper and lower half casings.

Further, the grill net has a silicon mounted at its outer peripheral edge.

According to the construction as described above, when cooking, the food smell, gas and the like is discharged to the lower portion of the lower half casing by means of the silicon mounted at the outer peripheral edges of the discharge opening/closing means and the grill net, and then is combusted by a flame of a gas stove, thereby effectively removing the food odor.

### DESCRIPTION OF DRAWINGS

Further objects and advantages of the invention can be more fully understood from the following detailed description taken in conjunction with the accompanying drawings, in which:

FIG. 1 is a top plan view of a fry pan for removing odor according to the present invention;

FIG. 2 is a side cross-sectional view of a fry pan for removing odor according to the present invention;

FIG. 3 is an exploded side cross-sectional view of a fry pan for removing odor according to the present invention; and

FIG. 4 is a side cross-sectional view showing a guide passageway and a discharge opening/closing means of a fry pan for removing odor according to the present invention.

### BEST MODE

Hereinafter, a preferred embodiment of the invention will be explained in detail with reference to the appended drawings.

Of course, the preferred embodiment of the invention is not limited to the particular examples, which have been used merely as an example rather than limitation, and changes and modifications of the specifically described embodiments can be carried out without departing from the scope of the invention.

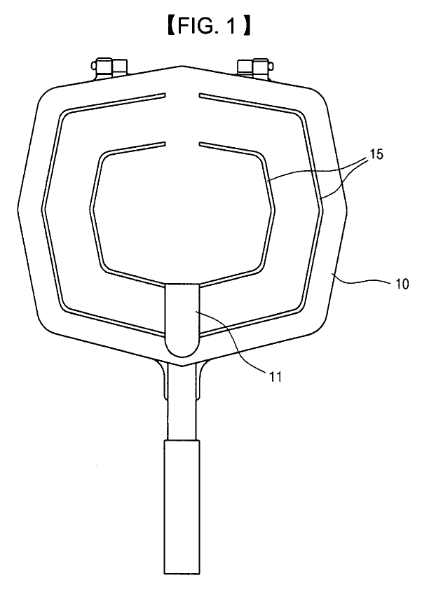

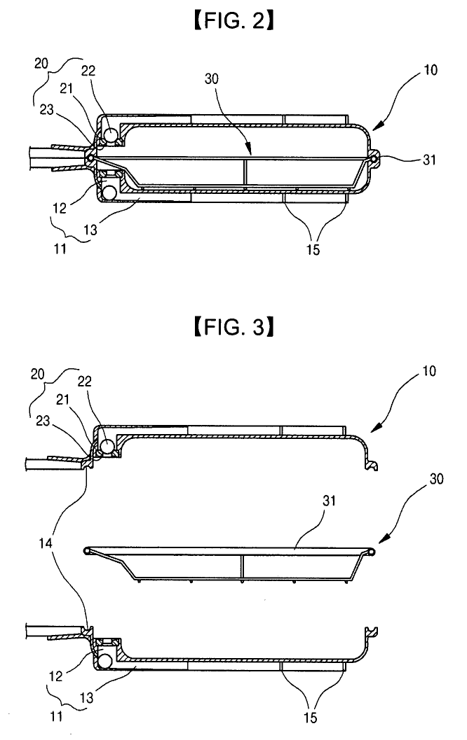

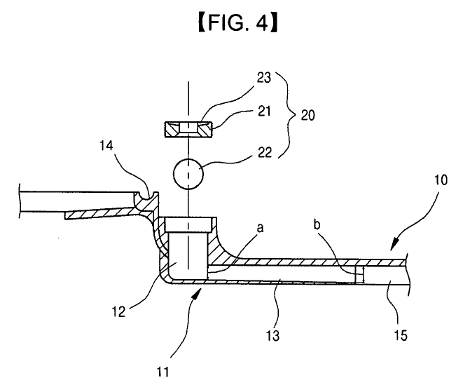

FIG. 1 is a top plan view of a fry pan for removing odor according to the invention, FIG. 2 is a side cross-sectional view of a fry pan for removing odor according to the invention, FIG. 3 is an exploded side cross-sectional view of a fry pan for removing odor according to the invention; and FIG. 4 is a side cross-sectional view showing a guide passageway and a discharge opening/closing means of a fry pan for removing odor according to the invention.

As shown in drawings, the fry pan for removing an odor comprises a body including an upper half casing and a lower half casing combined together 10 and having a guide passageway 11 formed penetratingly therein in such a manner as to intercommunicate with a side of the inside thereof and the outside thereof, respectively, a discharge opening/closing means 20 disposed at an end of the body for opening/closing the guide passageway 11, and a grill net 30 mounted along the outer peripheral edge of the body for putting a food to be cooked thereon as well as filling up the gap between the upper and lower half casings 10.

The guide passageway 11 has a first guide passageway 12 internally formed in a side of the upper and lower half casings 10, respectively, and a second guide passageway 13 elongatedly formed on the top and underside surfaces of the upper and lower half casings 10. The cross sectional area of the second guide passageway 13 is formed smaller than that of the first guide passageway 12, thereby preventing the discharge opening/closing means 20 from being moved into the second guide passageway 13, as well as allowing a smell from the inside of the upper and lower half casings 10 to be readily discharged to the outside.

At this time, the second guide passageway 13 is constructed such that the cross sectional area of the second guide passageway 13 becomes larger as it goes from one end (a) of the second guide passageway 13 connected to the first guide passageway 12 toward the other end (b) thereof connected to the outside, so that a smell or gas flown from the first guide passageway 12 is naturally discharged along the second guide passageway 13 having its gradually expanded cross sectional area to the outside, and thus complete combustion is performed. As a result, a pressure generated by the expanded gas inside the second guide passageway 2 due to the narrow passageway can be prevented.

Meanwhile, the second guide passageway 13 may be integrally formed with the upper and lower half casings 10 when molding the upper and lower half casings 10, or otherwise may be formed after molding the upper and lower bodies 10 such that a plurality of loop-shaped support protrusion 15 is formed in such a manner as to be partially discontinued at a portion facing the second guide passageway 13 so as to allow the second guide passageway 13 to be readily penetratingly formed. The first guide passageway 12 is penetratingly formed by machining after molding the upper and lower bodies 10, and then the discharge opening/closing means 20 is disposed at an end of the first guide passageway 12.

The discharge opening/closing means 20 includes a discharge bolt valve 21 mounted at an end of the first guide passageway 12, and an opening/closing ball 22 mounted movably within the first guide passageway 12.

The discharge bolt valve 21 has a hollow formed in its interior, and a screw thread formed at the outer peripheral surface thereof so as to be threadably engaged to the end of the first guide passageway 12. The opening/closing ball 22 functions to open or close the hollow of the discharge bolt valve 21 depending on the position of the upper and lower bodies 10, thereby preventing the smell or gas from being discharged upwardly through the first and second guide passageways.

Further, the opening/closing ball 22 of the discharge opening/closing means 20 of the upper half casing 10 is moved downwardly to close the hollow of the discharge opening/closing means 20, thereby preventing the smell and gas from being discharged upwardly, while the opening/closing ball 22 of the lower half casing 10 is moved downwardly to open the hollow of the discharge opening/closing means 20, thereby allowing the smell and gas from being discharged to the outside.

In addition, the opening/closing ball 22 has a silicon or a coating material such as rubber (not shown) formed or covered on its outer peripheral surface, as needed, thereby relatively tightly sealing the hollow of the discharge opening/closing means 21.

In the meantime, the upper and lower half casing 10 has a resting groove 14 formed along their outer peripheral edges, respectively, thereby allowing the outer peripheral edge of the grill net 30 to be rested thereon.

At this time, a sealing element 31 is disposed at the outer peripheral edge of the grill net 30. The sealing element 31 coated a silicon material having its excellent thermal resistance is preferably used. Also, the grill net 30 is fabricated with an identical shape and size to those of the upper and lower bodies 10.

Further, when the grill net 30 is not used, a separate sealing element is provided and fitted into the resting groove 14 of the upper and lower half casings 10 to thereby maintain air tightness of the inside of the upper and lower half casings 10, so that the smell and gas and the like of the inside of the upper and lower half casings 10 can be re-combusted by a flame of the gas stove while being discharged along the first and second guide passageways to the gas discharge opening.

In addition, the upper and lower half casings 10 has a plurality of loop-shaped support protrusions 15 outwardly protruded from the top and underside surfaces thereof, respectively, thereby supporting the upper and lower half casings 10 in such a manner as to be horizontally placed on the ground, as well as allowing the smell and gas discharged from the guide passageway 11 to be congested by the loop-shaped support protrusions 14 and hence be completely combusted.

Meanwhile, the outer appearance of the upper and lower half casings is formed in an octangular shape in the drawings. However, it may be formed in a circular shape, elliptical shape or polygonal shape such as a quadrangle not shown in drawings.

### ADVANTAGEOUS EFFECTS

As described above, according to the present invention, a food odor and gas and the like produced when cooking is discharged only to the lower portion of the lower half casing due to the air-tightness by the silicon formed along the outer peripheral edges of the discharge opening/closing means and the grill net, respectively, and is combusted by a flame of a gas stove, thereby effectively removing the food odor.

Further, according to the present invention, a fish and the like is not in direct contact with the bottom surface of the lower half casing by means of the grill net and a space into which the oil and moisture is fallen is formed, thereby effectively cooking the fish with full of flavor. When cooking other than fish, the upper half casing without the grill net can turn it upside down, so that the upper and lower half casings can be selectively used depending on the food to be cooked.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A fry pan for removing an odor comprising:
a body 10 including an upper half casing and a lower half casing combined together and having a guide passageway 11 formed penetratingly therein in such a manner as to intercommunicate with a side of the inside thereof and the outside thereof, respectively;
a discharge opening/closing means 20 disposed at an end of the body for opening/closing the guide passageway 11; and
a grill net 30 mounted along the outer peripheral edge of the body for putting a food to be cooked thereon.

2. The fry pan for removing an odor according to claim 1, wherein the guide passageway 11 of the body includes:
a first guide passageway 12 internally formed in a side of the upper and lower half casings 10, respectively; and
a second guide passageway 13 elongatedly formed on the top and underside surfaces of the upper and lower half casings 10, the second guide passageway 13 having a cross-sectional area smaller than that of the first guide passageway,
whereby the cross sectional area of the second guide passageway 13 becomes larger as it goes from one end of the second guide passageway 13 connected to the first guide passageway 12 toward the other end thereof connected to the outside.

3. The fry pan for removing an odor according to claim 1, wherein the discharge opening/closing means 20 includes:
a discharge bolt valve 21 mounted at an end of the first guide passageway 12, the discharge bolt valve 21 having a hollow formed in its interior; and
an opening/closing ball 22 mounted movably within the guide passageway 11 for opening or closing the hollow of the discharge bolt valve 21 depending on the use position of the upper and lower half casings 10.

4. The fry pan for removing an odor according to claim 1, wherein the grill net 30 has a silicon mounted at its outer peripheral edge.
